(19) United States
(12) Patent Application Publication
(10) Pub. No.: US 2002/0134024 A1
(43) Pub. Date: Sep. 26, 2002

(54) Door assembly for a vehicle and assembling method thereof

(76) Inventor: Suk-Hwan kim, Suwon-City (KR)

Correspondence Address: CHRISTIE, PARKER & HALE, LLP, 350 WEST COLORADO BOULEVARD, SUITE 500, PASADENA, CA, 91105, US

(21) Appl. No.: 09/815,775

(22) Filed: Mar. 22, 2001

(51) Int. Cl. B60J 5/04

(52) U.S. Cl. 49/502; 49/506

(57) ABSTRACT

A door assembly for vehicle adapted to simplify a door assembly process thereby improving a door assembly efficiency, the door assembly for vehicle, comprising: a door trim assembly mounted with a window regulator assembly necessary for lifting a door window glass and a door lock assembly for opening and closing a door; and a door panel assembly coupled to the door trim assembly.

### BACKGROUND OF THE INVENTION

1. Field of the Invention

The present invention relates to a door assembly, and more particularly to a door assembly for vehicle adapted to simplify assembly process of the vehicle thereby improving assembly efficiency.

2. Description of the Prior Art

In general, a vehicle is equipped with openable and closeable doors for passengers to get in and out, and open/close apparatus are installed thereto for opening and closing the doors.

As illustrated in FIG. 2, a door assembly for vehicle comprises a door panel assembly 52 assembled by inner and outer panel 50 and 51; a window regulator assembly (a window regulator (R) and a glass run channel (G) and so on), a door lock assembly (a door latch (L) and a door lock actuator (LA) and so on), a door speaker (S) and a door wiring (W) installed inside the door panel assembly 52; and a door trim 53 attached to the inner panel 50 to form an interior of the vehicle.

Now, an assembled state of the door will be described.

First, the door panel assembly 52 is formed by welding the inner/outer panels 50 and 51 each other and the door panel assembly 52 is coupled to a plurality of parts for lifting the door window glass and opening and closing the door.

When the door panel assembly 52 is mounted with the plurality of parts, the door trim 53 is coupled to the door inner panel 50 to complete the door.

However, there is a problem in the door assembly process thus described in that the door panel assembly is assembled to attach parts for operating the door window glass and the like and then the door trim is attached to the inner panel, process for mounting the parts to the door panel assembly becomes complicated due to a large number of parts.

In other words, the process of mounting a door wiring, a door latch, an inner handle, an inner handle rod, a window regulator, a door speaker and the like to the door panel assembly gets too much complicated to thereby decrease door assembly efficiency.

### SUMMARY OF THE INVENTION

The present invention is disclosed to solve the aforementioned problem and it is an object of the present invention to provide a door assembly for vehicle adapted to simplify a door assembly process thereby improving a door assembly efficiency.

In accordance with the object of the present invention, there is provided a door assembly for vehicle, the assembly comprising: a door trim assembly mounted with a window regulator assembly necessary for lifting a door window glass and a door lock assembly for opening and closing a door; and a door panel assembly coupled to the door trim assembly.

There is provided a method for assembling a door assembly, the method comprising the steps of: preparing a door trim; assembling a door trim assembly by mounting a window regulator assembly necessary for lifting a door window glass and a door lock assembly for opening and closing a door to the door trim; assembling a door panel assembly; and coupling the door trim assembly to the door panel assembly.

### BRIEF DESCRIPTION OF THE DRAWINGS

For fuller understanding of the nature and objects of the invention, reference should be made to the following detailed description taken in conjunction with the accompanying drawings in which:

FIG. 1 is a schematic perspective view for illustrating a door assembly for vehicle according to the present invention; and

FIG. 2 is a schematic perspective view for illustrating a door assembly for vehicle according to the prior art.

### DETAILED DESCRIPTION OF THE INVENTION

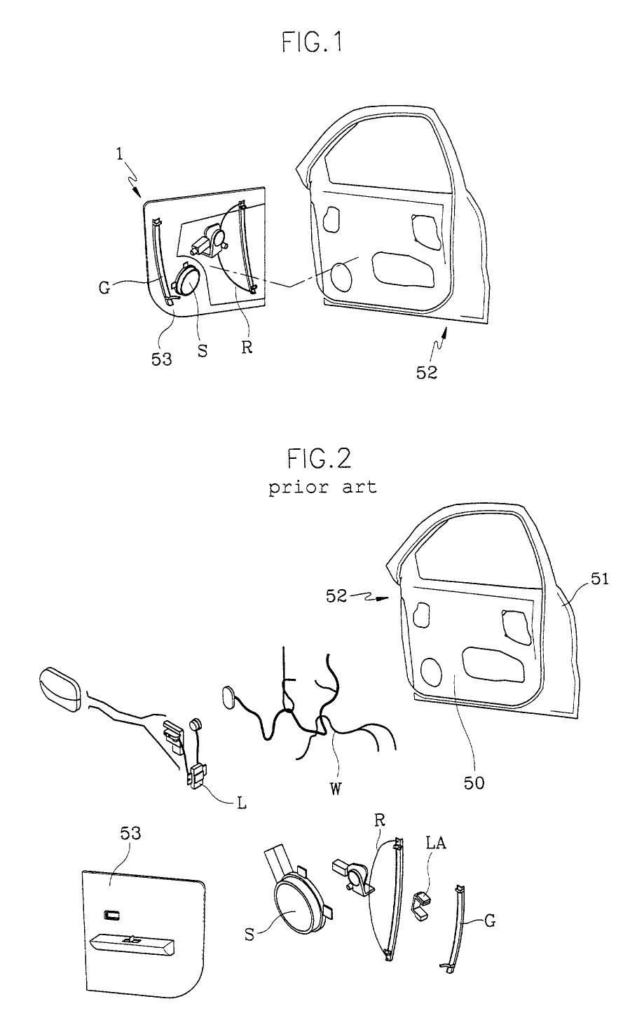

FIG. 1 is a schematic perspective view for illustrating a door assembly for vehicle according to the present invention, where a door assembly is completed when a door panel assembly 52 is mounted to a door trim assembly 1 where the door trim 53 is mounted at an inner surface thereof by a door wiring (W), a door speaker (S), a window regulator assembly (a window regulator (R) and a glass run channel (G) and so on), a door lock assembly (a door latch (L) and a door lock actuator (LA) and so on) and the like.

In other words, a plurality of the above parts are assembled to the door trim 53 for modularization to make the door trim assembly 1, and the door assembly can be completed when the door trim assembly 1 is coupled to the door panel assembly 52.

Of course, the door panel assembly 52 where the parts are received and the parts are so constructed as not to be mutually interfered when the parts are assembled to the door trim 53 to be attached to the door panel assembly 52.

Now, operational effect of the present invention thus constructed will be described.

First, a plurality of parts (parts for lifting door glass window and parts for opening and closing the door), for example, the regulator (R), door wiring (W), door latch (L), inner handle and the like, are assembled onto the door trim 53 to finish assembly of the door trim assembly 1 and the door panel assembly 52 is also independently assembled.

When the door trim assembly 1 and the door panel assembly 52 are respectively put together, the door trim assembly 1 is assembled with the door panel assembly 52 to complete the door assembly.

In other words, the door trim assembly 1 is assembled at one process while the door panel assembly 52 is assembled at another process, whereby, when the two assemblies are coupled, an assembly process can be simplified on a door assembly line.

Of course, when the door trim assembly 1 is assembled in module, only thing for the door assembly line to do is to keep the door trim assembly 1 and the door panel assembly 52, such that space for safekeeping products can be minimized.

Furthermore, the plurality of parts mounted to the door trim 53 are not needed to be kept in separate individual state and are stored in the state of door trim assembly 1 while being secured to the door trim 53, such that logistics cost of parts can be reduced in comparison to method where the plurality of parts are individually stored.

Particularly, parts directly assembled in the door assembly line are moduled to only two pars of door trim assembly 1 and door panel assembly 52 to improve an assembly efficiency thereof to a great extent.

As apparent from the foregoing, there is an advantage in the door assembly for vehicle thus described according to the present invention in that a door trim is mounted by parts such as a door wiring, a door window regulator and the like for moduling, which is then coupled to a door panel assembly to construct a door assembly, such that a door assembly efficiency is enhanced and logistics cost resultant therefrom is also reduced.

What is claimed is:

1. A door assembly for vehicle, the assembly comprising:
a door trim assembly mounted with a window regulator assembly necessary for lifting a door window glass and a door lock assembly for opening and closing a door;
and a door panel assembly coupled to the door trim assembly.

2. The door assembly as defined in claim 1, wherein the door panel assembly comprises an inner panel and an outer panel coupled to the inner panel.

3. A method for assembling a door assembly, the method comprising the steps of:
preparing a door trim;
assembling a door trim assembly by mounting a window regulator assembly necessary for lifting a door window glass and a door lock assembly for opening and closing a door to the door trim;
assembling a door panel assembly; and
coupling the door trim assembly to the door panel assembly.

4. The method as defined in claim 3, wherein the door panel assembly comprises an inner panel and an outer panel coupled to the inner panel.
